(19) United States
(12) Patent Application Publication
(10) Pub. No.: US 2015/0039312 A1
(43) Pub. Date: Feb. 5, 2015

(54) CONTROLLING SPEECH DIALOG USING AN ADDITIONAL SENSOR

(71) Applicant: GM GLOBAL TECHNOLOGY OPERATIONS LLC, Detroit, MI (US)

(72) Inventors: ELI TZIRKEL-HANCOCK, RA'ANANA (IL); JAN H. AASE, OAKLAND TOWNSHIP, MI (US); ROBERT D. SIMS, III, MILFORD, MI (US); IGAL BILIK, REHOVOT (IL); MOSHE LAIFENFELD, HAIFA (IL)

(73) Assignee: GM GLOBAL TECHNOLOGY OPERATIONS LLC, Detroit, MI (US)

(21) Appl. No.: 13/955,265

(22) Filed: Jul. 31, 2013

(51) Int. Cl. G10L 15/26; G10L 17/00; G10L 15/22

(52) U.S. Cl. CPC G10L 15/265; G10L 15/222; G10L 17/005; G10L 2015/226
USPC 704/246; 704/275

(57) ABSTRACT

Methods and systems are provided for managing speech dialog of a speech system. In one embodiment, a method includes: receiving information determined from a non-speech related sensor; using the information in a turn-taking function to confirm at least one of if and when a user is speaking; and generating a command to at least one of a speech recognition module and a speech generation module based on the confirmation.

### TECHNICAL FIELD

The technical field generally relates to speech systems, and more particularly relates to methods and systems for controlling dialog within a speech system based on information from a non-speech related sensor.

### BACKGROUND

Vehicle speech systems perform speech recognition or understanding of speech uttered by occupants of the vehicle. The speech utterances typically include commands that communicate with or control one or more features of the vehicle or other systems that are accessible by the vehicle. A speech dialog system of the vehicle speech system generates spoken commands in response to the speech utterances or to elicit speech utterances or other user input. In some instances, the spoken commands are generated in response to the speech system needing further information in order to perform a desired task. In other instances, the spoken commands are generated as a confirmation of the recognition result.

Some speech systems perform the speech recognition/understanding and generate the spoken commands based on one or more turn-taking steps or functions. For example, a dialog manager manages the dialog based on various scenarios that may occur during a conversation. The dialog manager, for example, manages when the vehicle speech system should be listening for speech uttered by a user and when the vehicle speech system should be generating spoken commands to the user. It is desirable to provide methods and systems for enhancing turn-taking in a speech system. Furthermore, other desirable features and characteristics of the present invention will become apparent from the subsequent detailed description and the appended claims, taken in conjunction with the accompanying drawings and the foregoing technical field and background.

### SUMMARY

Accordingly, methods and systems are provided for managing speech dialog of a speech system. In one embodiment, a method includes: receiving information determined from a non-speech related sensor; using the information in a turn-taking function to confirm at least one of if and when a user is speaking; and generating a command to at least one of a speech recognition module and a speech generation module based on the confirmation.

In another embodiment, a system includes a first module that receives information determined from a non-speech related sensor, and that uses the information in a turn-taking function to confirm at least one of if and when a user is speaking. A second module at least one of starts and stops at least one of speech recognition and speech generation based on the confirmation.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIG. 2 is a dataflow diagram illustrating a speech system in accordance with various exemplary embodiments; and

FIG. 3 is a flowchart illustrating a speech method that may be performed by the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

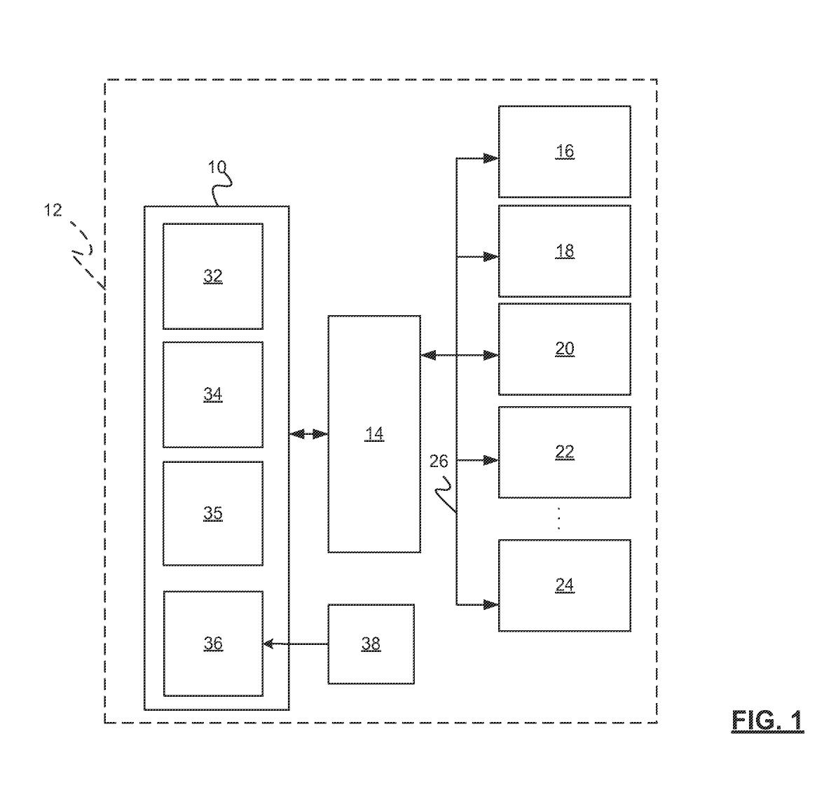

Referring now to FIG. 1, in accordance with exemplary embodiments of the present disclosure a speech system 10 is shown to be included within a vehicle 12. In various exemplary embodiments, the speech system 10 provides speech recognition or understanding and a dialog for one or more vehicle systems through a human machine interface module (HMI) module 14. Such vehicle systems may include, for example, but are not limited to, a phone system 16, a navigation system 18, a media system 20, a telematics system 22, a network system 24, or any other vehicle system that may include a speech dependent application. As can be appreciated, one or more embodiments of the speech system 10 can be applicable to other non-vehicle systems having speech dependent applications and thus, is not limited to the present vehicle example.

The speech system 10 and/or the HMI module 14 communicate with the multiple vehicle systems 16-24 through a communication bus and/or other communication means 26 (e.g., wired, short range wireless, or long range wireless). The communication bus can be, for example, but is not limited to, a controller area network (CAN) bus, local interconnect network (LIN) bus, or any other type of bus.

The speech system 10 includes a speech recognition module 32, a dialog manager module 34, and a speech generation module 35. As can be appreciated, the speech recognition module 32, the dialog manager module 34, and the speech generation module 35 may be implemented as separate systems and/or as a combined system as shown. In general, the speech recognition module 32 receives and processes speech utterances from the HMI module 14 using one or more speech recognition or understanding techniques that rely on acoustic modeling, semantic interpretation and/or natural language understanding. The speech recognition module 32 generates one or more possible results from the speech utterance (e.g., based on a confidence threshold) to the dialog manager module 34.

The dialog manager module 34 manages an interaction sequence and a selection of speech prompts to be spoken to the user based on the results. In various embodiments, the dialog manager module 34 determines a next speech prompt to be generated by the system in response to the user's speech utterance. The speech generation module 35 generates a spoken command that is to be spoken to the user (e.g., via the HMI module) based on the next speech prompt provided by the dialog manager.

As will be discussed in more detail below, the speech system 10 further includes a sensor data interpretation module 36. The sensor data interpretation module 36 processes data received from a non-speech related sensor 38 and provides sensor information to the dialog manager module 34. The non-speech related sensor 38 can include, for example, but is not limited to, an image sensor, an ultrasound sensor, a radar sensor, or other sensor that senses non-speech related observable conditions of one or more occupants of the vehicle. As can be appreciated, in various embodiments, the non-speech related sensor 38 can be a single sensor that senses all occupants of the vehicle 12 or alternatively, may include multiple sensors that each senses a potential occupant of the vehicle 12, or that sense all occupants of the vehicle 12. For exemplary purposes, the disclosure will be discussed in the context of the non-speech related sensor 38 being a single sensor.

The sensor data interpretation module 36 processes the sensor data to determine which occupant is interacting with the HMI module 14 (e.g., if there are multiple occupants in the vehicle 12) and further processes the sensor data to determine the presence of speech from the occupant (e.g., whether or not the occupant is talking at a particular time). For example, in the case of the image sensor, the sensor data interpretation module 36 processes image data to determine the presence of speech, for example, based on whether or not the lips are open or closed, based on a rate of movement of the lips, or based on other detected facial expressions of the occupant. In another example, in the case of the ultrasound sensor, the sensor data interpretation module 36 processes ultrasound data to determine the presence of speech, for example, based on a detected movement or velocity of an occupant's lips. In yet another example, in the case of the radar sensor, the sensor data interpretation module 36 processes radar data to determine the presence of speech based on a detected movement or velocity of an occupant's lips.

The dialog manager module 34 receives information from the sensor data interpretation module 36 indicating the presence of speech from a particular occupant (referred to as a user of the system 10). In various embodiments, the information includes a probability of speech presence from an occupant. The dialog manager module 34 manages the dialog with the user based on the information from the sensor data interpretation module 36. For example, the dialog manager module 34 uses the information in various turn-taking functions to confirm if and/or when the user is speaking.

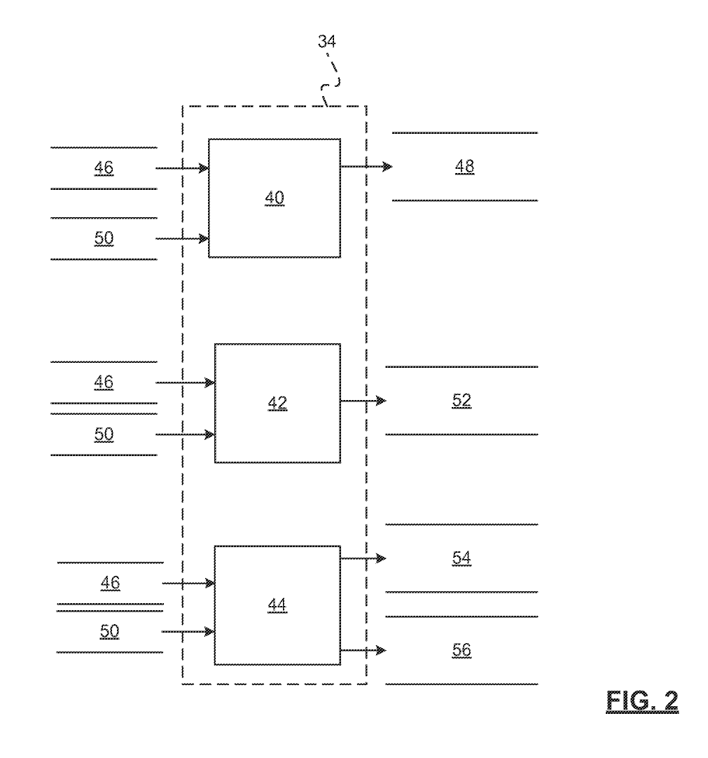

Referring now to FIG. 2 and with continued reference to FIG. 1, a dataflow diagram illustrates components of the dialog manager module 34 in accordance with various exemplary embodiments. As can be appreciated, various exemplary embodiments of the dialog manager module 34, according to the present disclosure, may include any number of sub-modules. In various exemplary embodiments, the sub-modules shown in FIG. 2 may be combined and/or further partitioned to similarly manage the speech dialog based on the information from the sensor data interpretation module 36. In various exemplary embodiments, the dialog manager module 34 includes a one or more turn-taking modules that each performs one or more turn-taking functions.

In various embodiments, the turn-taking modules can include, but are not limited to, a system start module 40, a listening window determination module 42, and a barge-in detection module 44. Each of the turn-taking modules make use of the information from the sensor data interpretation module 36 to confirm if and when a particular user is speaking and to generate commands to either the speech recognition module 32 and/or the speech generation module 35 based on the confirmation. As can be appreciated, the dialog manager module 34 may include other turn-taking modules that perform one or more turn-taking functions that make use of the information from the sensor data interpretation module 36 to confirm if and when a particular user is speaking, and is not limited to the examples illustrated in FIG. 2.

With reference now to the specific examples shown in FIG. 2, the system start module 40 enables the user to start or wake up the speech system 10 based on an utterance 46 of a particular word (e.g., a magic word). For example, the system start module 40 listens for a particular word or words to be uttered by a particular user. Once the particular word has been uttered and recognized, the system start module 40 generates a command 48 to start the system 10 such that speech dialog can occur. For example, the command 48 can be generated to the speech recognition module 32 to perform the recognition or to the speech generation module 35 to generate a spoken command to initiate a dialog.

In various embodiments, the system start module 40 uses information 50 from the sensor data interpretation module 36 to confirm that a particular user is speaking In various embodiments, the system start module 40 uses the information 50 from the sensor data interpretation module 36 to detect when a particular user is speaking and to initiate monitoring for the magic word(s). By using the information 50 from the sensor data interpretation module 36, the system start module 40 is able to prevent false recognitions of noise as the magic word.

The listening window determination module 42 determines a speaking window in which the user may speak after a spoken command is generated and/or before another spoken command is generated. For example, the listening window determination module 42 determines a window of time in which speech input 46 by the user can be received and processed. Based on the window of time, the listening window determination module 42 generates a command 52 to start or stop the generation of a spoken command by the system 10.

In various embodiments, the listening window determination module 42 uses the information 50 from the sensor data interpretation module 36 to determine the window of time of listening to the user after a spoken command has been generated. The listening window can be extended or be determined flexibly in dependence of the speech prompt without risking false speech detection. By using the information 50 from the sensor data interpretation module 36, the turn determination module 42 is able to prevent a loss of turn by the user and/or to prevent a speak-over command issued by the system.

The barge-in detection module 44 enables the user to speak before the generation of the spoken command ends. For example, the barge-in detection module 44 receives speech input and detects whether a user has barged in to a spoken command issued by the system and determines whether to stop a spoken command upon detection of the barge-in. If barge-in has occurred, the barge-in detection module 44 generates a command or commands 54, 56 to stop the generation of the spoken command and/or to begin the speech recognition.

In various embodiments, the barge-in detection module 44 uses the information 50 from the sensor data interpretation module 36 to confirm that the speech input 46 received is from the particular occupant interacting with the system and to confirm that the speech input 46 is in fact speech. If the barge-in detection module 44 is able to confirm that the speech input 46 is from the particular occupant and is in fact speech, the barge-in detection module 44 issues the commands 54, 56 to stop the generation of the spoken command and/or to begin the speech recognition. By using the information 50 from the sensor data interpretation module 36, the barge-in detection module 44 is able to prevent undetected barge-in where the system 10 fails to detect that the user is speaking over the spoken prompt and/or to prevent false barge-in where the system 10 falsely cuts the prompt short and starts recognition when the user is not actually speaking

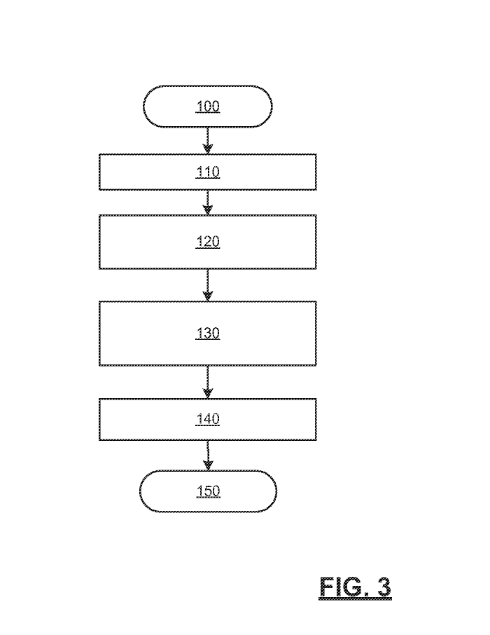

Referring now to FIG. 3, a flowchart illustrates a speech method that may be performed by the speech system 10 in accordance with various exemplary embodiments. As can be appreciated in light of the disclosure, the order of operation within the method is not limited to the sequential execution as illustrated in FIG. 3, but may be performed in one or more varying orders as applicable and in accordance with the present disclosure. As can further be appreciated, one or more steps of the method may be added or removed without altering the spirit of the method.

As shown, the method may begin at 100. At least one turn-taking function is selected based on the current operating scenario of the system 10 at 110. For example, if the system is asleep, then the system start function is selected. In another example, if the system is or is about to be engaging in a dialog, the listening window determination function is selected. In still another example, if the system is generating a spoken command, then a barge-in function is selected. As can be appreciated, other turn-taking functions may be selected thus the method is not limited to the present examples.

Thereafter, the information 50 from the sensor data interpretation module 36 is received at 120. The information 50 is then used in the selected function to confirm if and/or when a user of the vehicle 12 is speaking at 130. Commands 48, 52, 54, or 56 are generated the speech generation module 35 and/or the speech recognition module 32 based on the confirmation at 140. Thereafter, the method may end at 150. As can be appreciated, in various embodiments the method may iterate for any number of dialog turns.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for managing speech dialog of a speech system, comprising:
receiving information determined from a non-speech related sensor;
using the information in a turn-taking function to confirm at least one of if and when a user is speaking; and
generating a command to at least one of a speech recognition module and a speech generation module based on the confirmation.

2. The method of claim 1, further comprising determining at least one of if and when a user is speaking based on data received from the non-speech related sensor, and wherein the information is based on the determining.

3. The method of claim 1, wherein the using the information comprises using the information to confirm if a particular user is speaking

4. The method of claim 1, wherein the using the information comprises using the information to confirm when a user is speaking

5. The method of claim 1, wherein the using the information comprises using the information to confirm if and when a user is speaking

6. The method of claim 1, wherein the generating the command comprises generating the command to the speech recognition module to at least one of start and stop speech recognition.

7. The method of claim 1, wherein the generating the command comprises generating the command to the speech generation module to at least one of start and stop generation of a spoken command.

8. The method of claim 1, wherein the turn-taking function is a system start function.

9. The method of claim 1, wherein the turn-taking function is a barge-in function.

10. The method of claim 1, wherein the turn-taking function is a speech window determination function.

11. The method of claim 1 wherein the non-speech related sensor is at least one of an image sensor, an ultrasound sensor, and a radar sensor.

12. A system for managing speech dialog of a speech system, comprising:
a first module that receives information determined from a non-speech related sensor, and that uses the information in a turn-taking function to confirm at least one of if and when a user is speaking; and
a second module that at least one of starts and stops at least one of speech recognition and speech generation based on the confirmation.

13. The system of claim 12, further comprising a third module that determines at least one of if and when a user is speaking based on data received from the non-speech related sensor, and generates the information based on the determination.

14. The system of claim 12, wherein the first module uses the information to confirm if a particular user is speaking.

15. The system of claim 12, wherein the first module uses the information to confirm when a user is speaking.

16. The system of claim 12, wherein the first module uses the information to confirm if and when a user is speaking.

17. The system of claim 12, wherein the turn-taking function is a system start function.

18. The system of claim 12, wherein the turn-taking function is a barge-in function.

19. The system of claim 12, wherein the turn-taking function is a speech window determination function.

20. The system of claim 12, wherein the non-speech related sensor is at least one of an image sensor, an ultrasound sensor, and a radar sensor.
